(19) United States
(12) Patent Application Publication
(10) Pub. No.: US 2006/0134592 A1
(43) Pub. Date: Jun. 22, 2006

(54) Math and reading standardized test CD plus

(76) Inventor: Ryan C. H. Leacock, Uniondale, NY (US)

Correspondence Address: RYAN CHRISTOPHER HARCOURT LEACOCK, 401 CALIFORNIA AVENUE, UNIONDALE, NY, 11553, US

(21) Appl. No.: 10/823,807

(22) Filed: Apr. 12, 2004

(51) Int. Cl. G09B 7/00; G09B 3/00

(52) U.S. Cl. 434/322

(57) ABSTRACT

The Math and Reading Standardized Test Plus! is a CD idea designed to help children of elementary school age prepare for and take their Standardized Tests in the subject areas previously mentioned. A learning tool of this magnitude is purely based upon the curriculum of that specified grade. By incorporating levels of easy, medium, difficult and extreme difficult, children can advance or go to any specified level and see if they are prepared for that stage. There is a pretest level that can be implemented to automatically adjust settings. By putting in what I call the “extreme factor,” children will be able to take their pretest with background classroom noise (at certain levels) thus diminishing the stressor of test anxiety, which can lead to poor performance. It also provides students during the summer months with a “heads up” approach so they will be prepared for the upcoming grade.

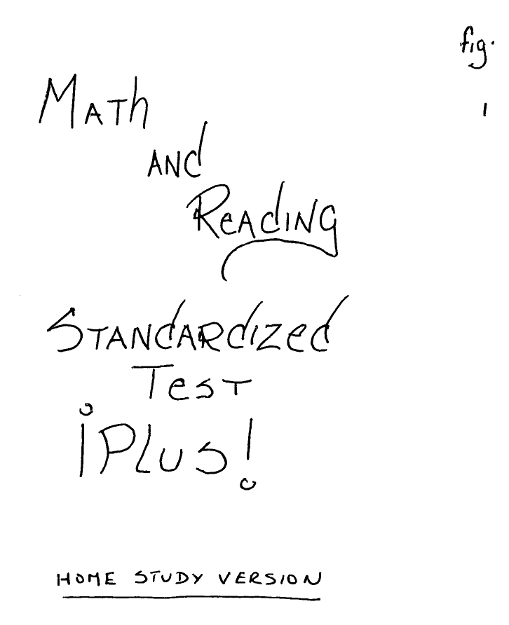

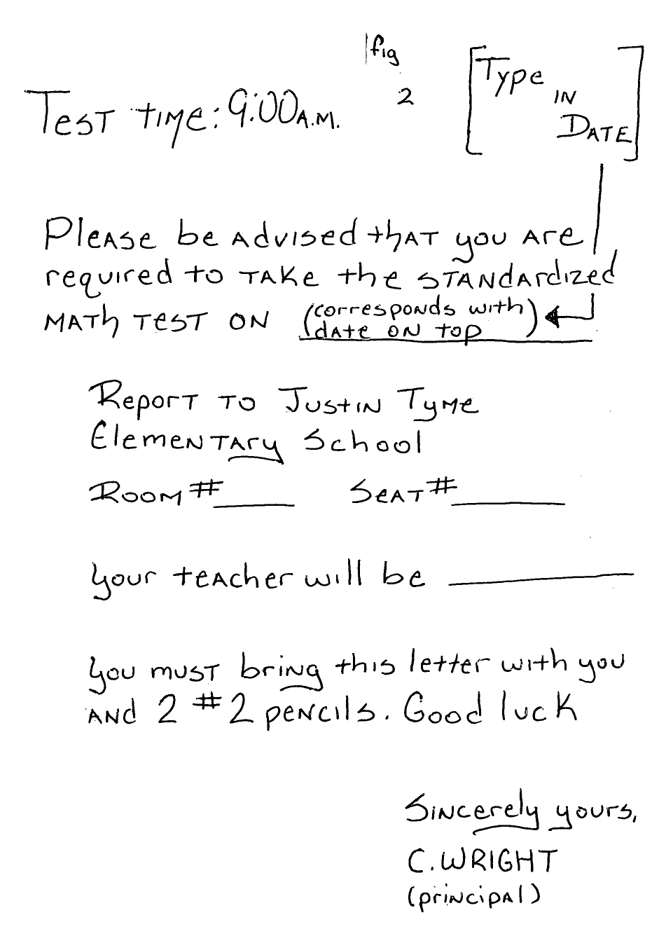

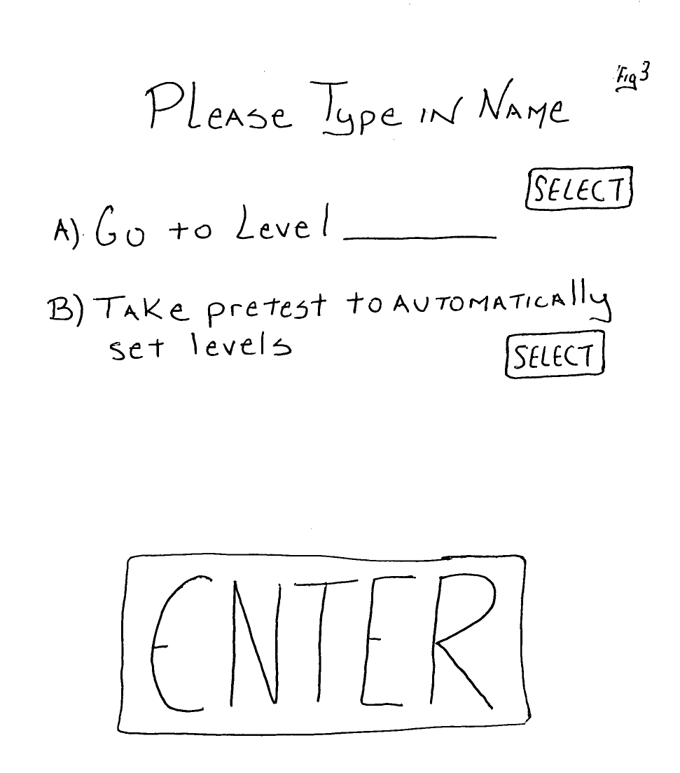

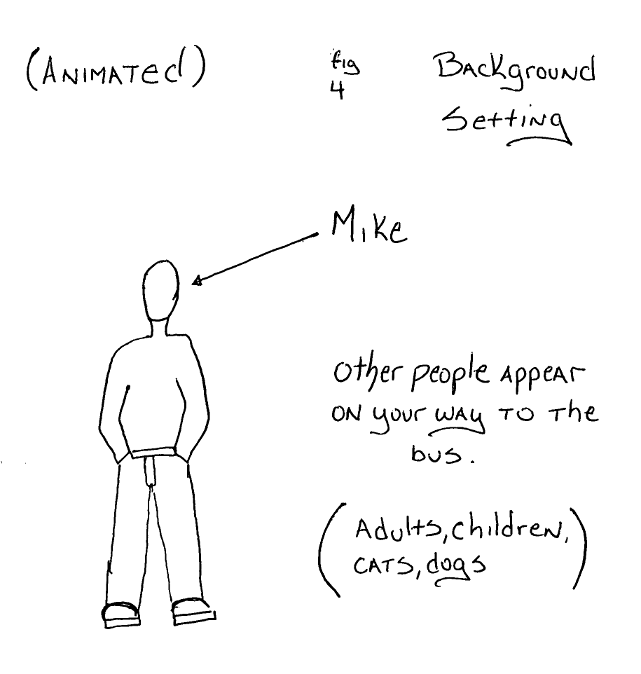

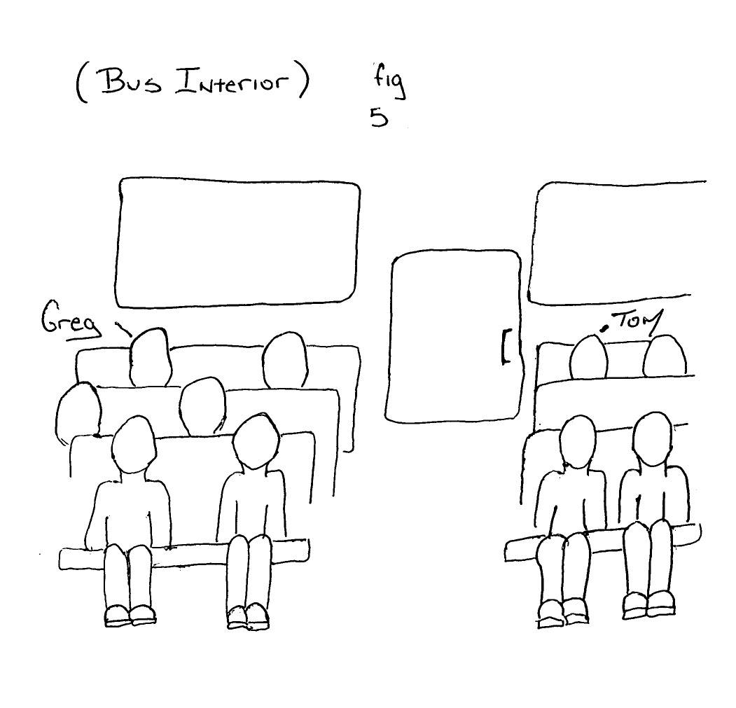

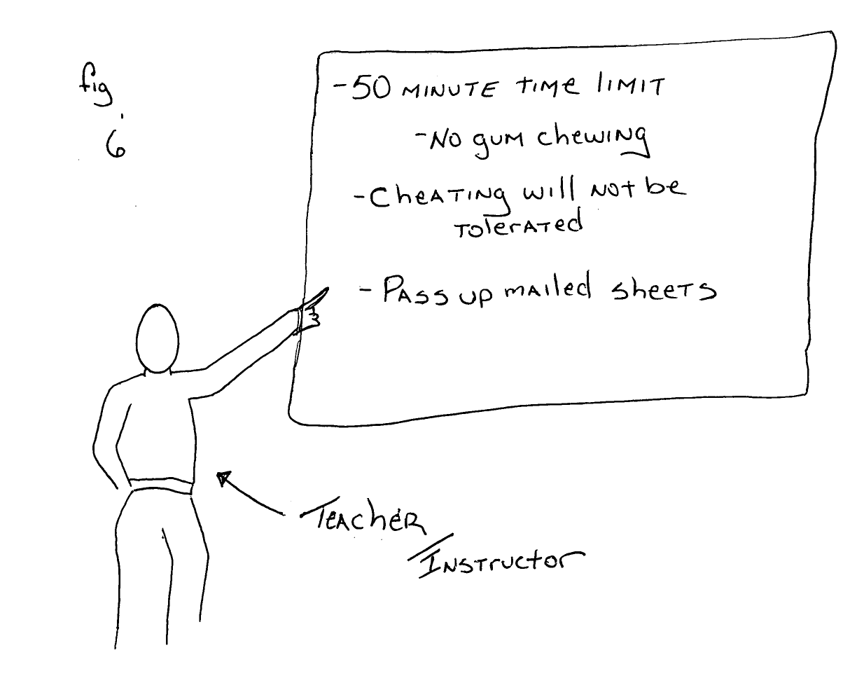

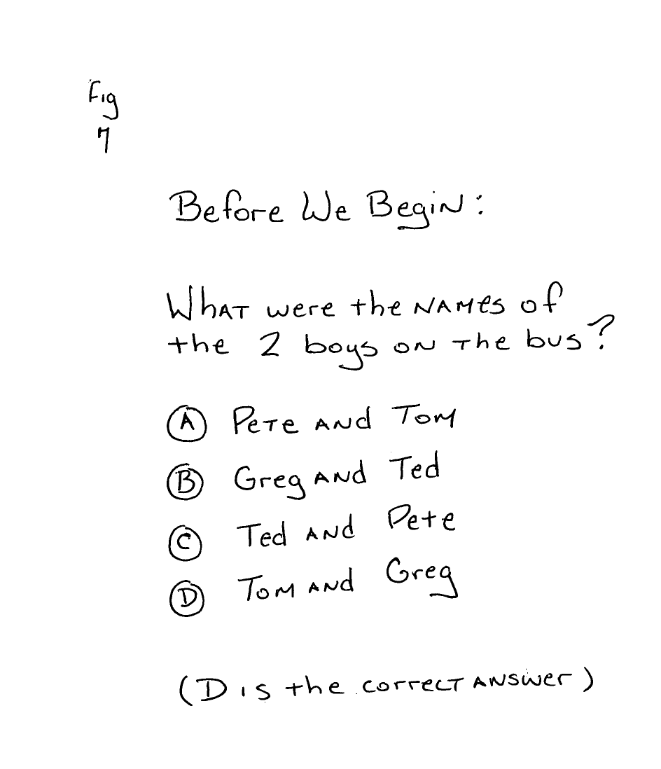

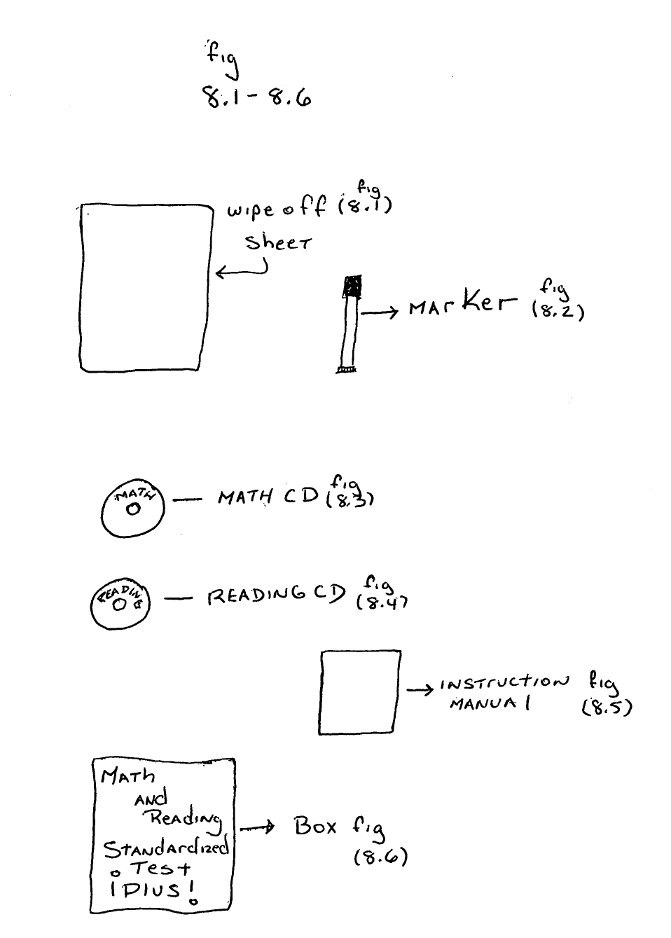

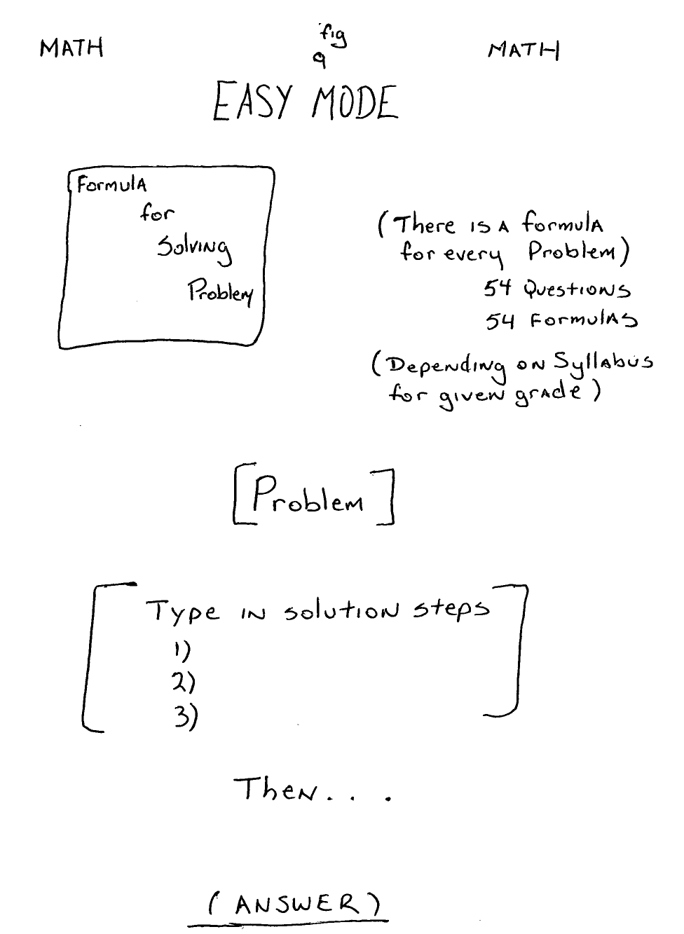

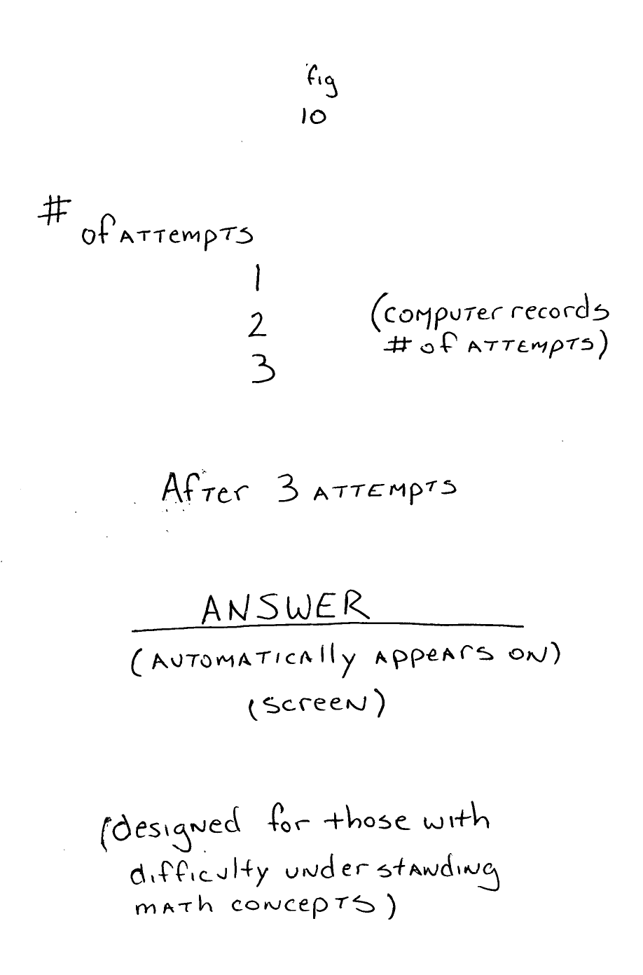

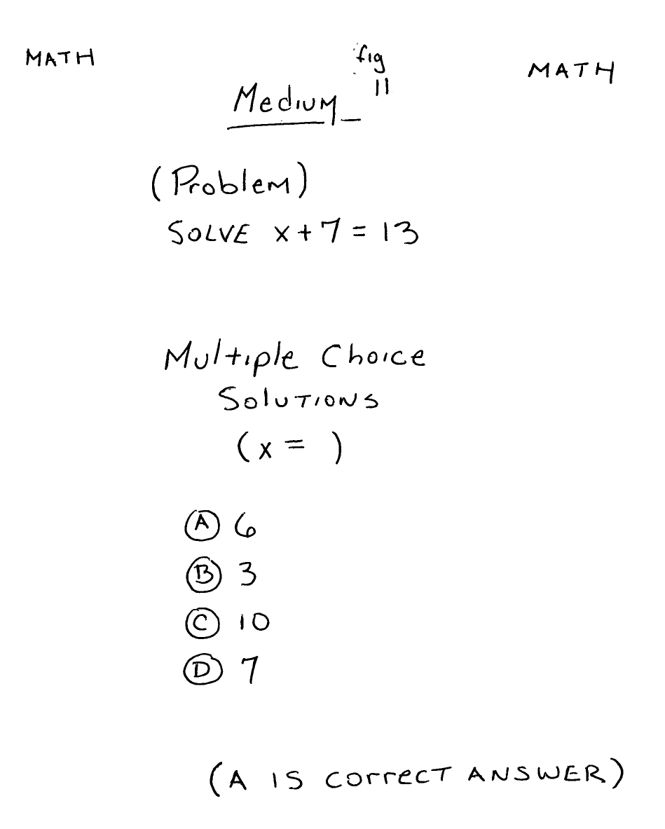

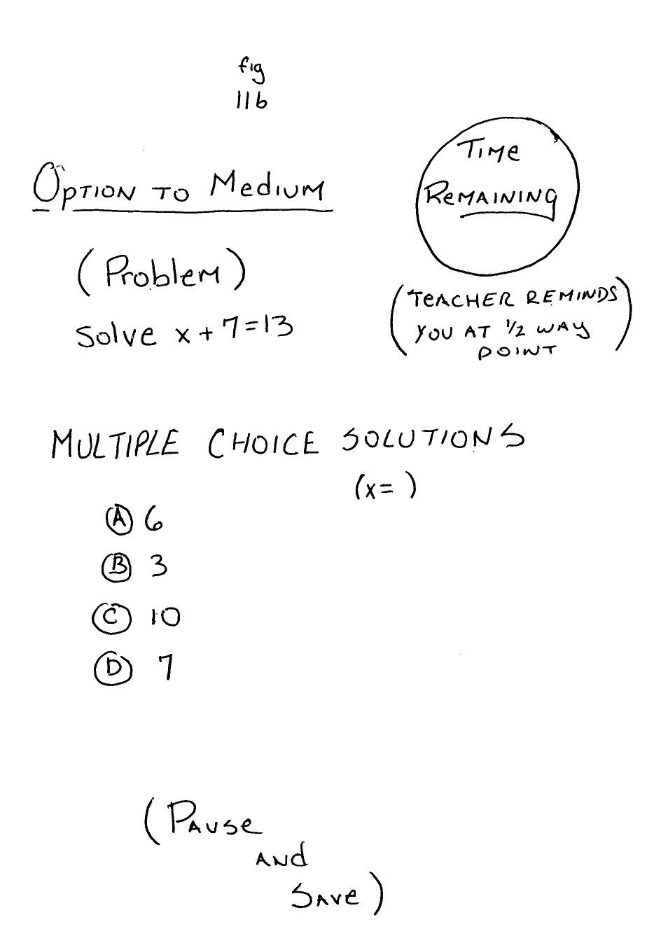

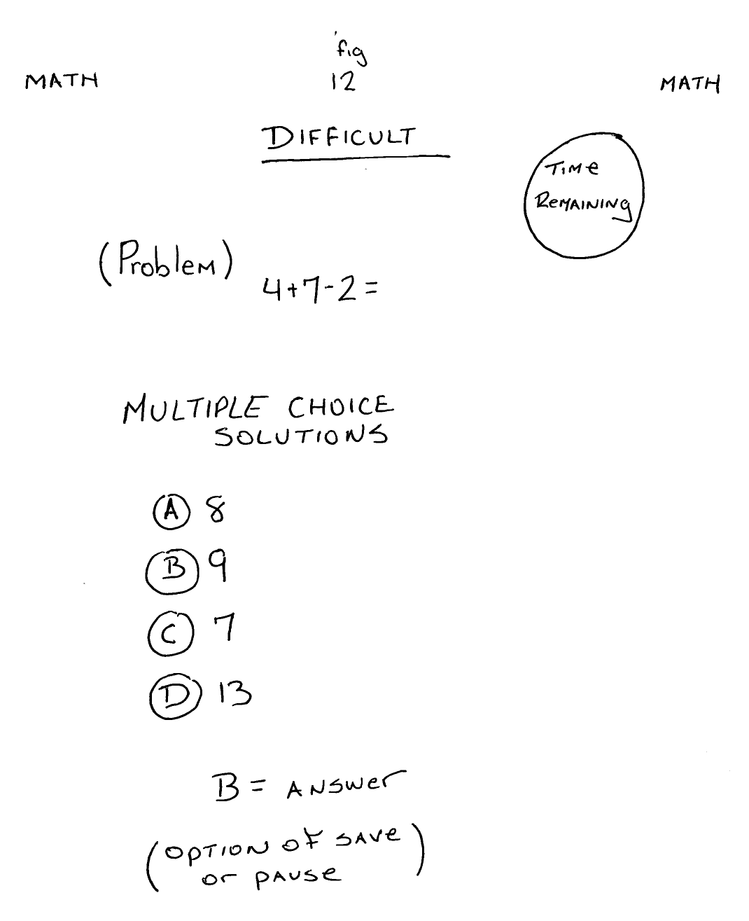

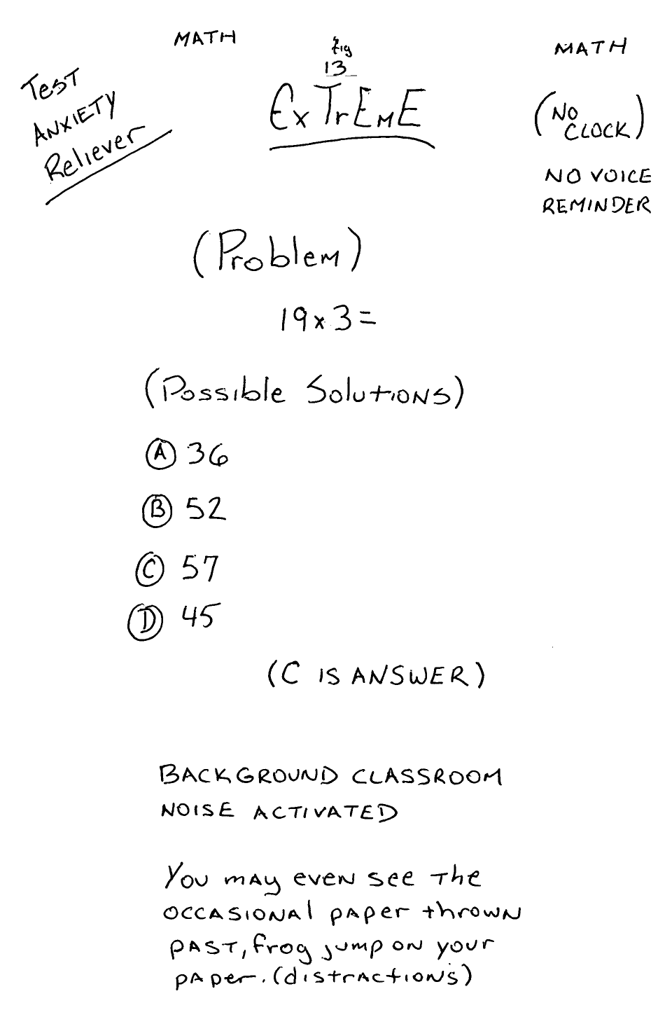

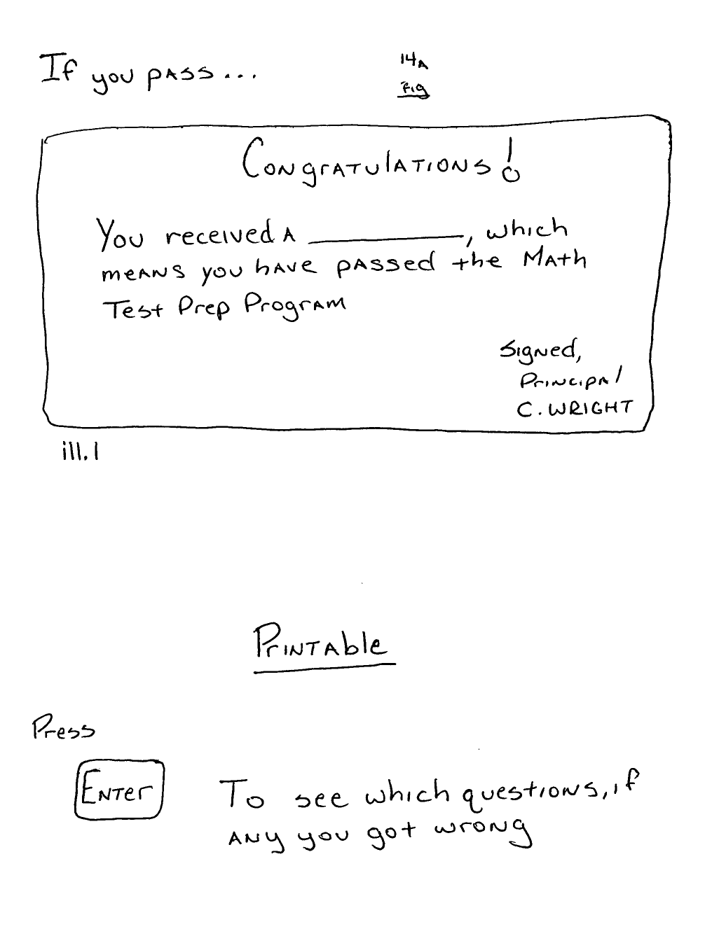

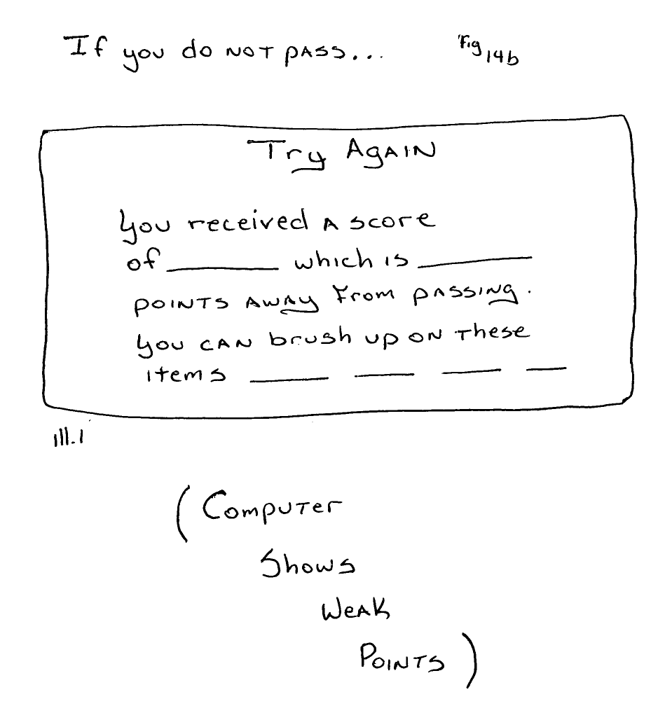

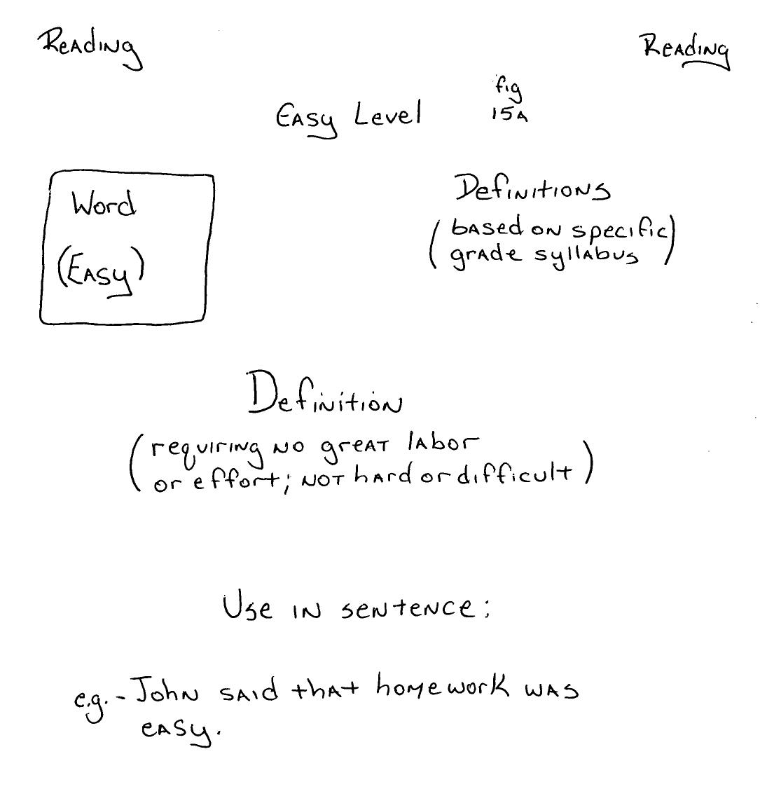

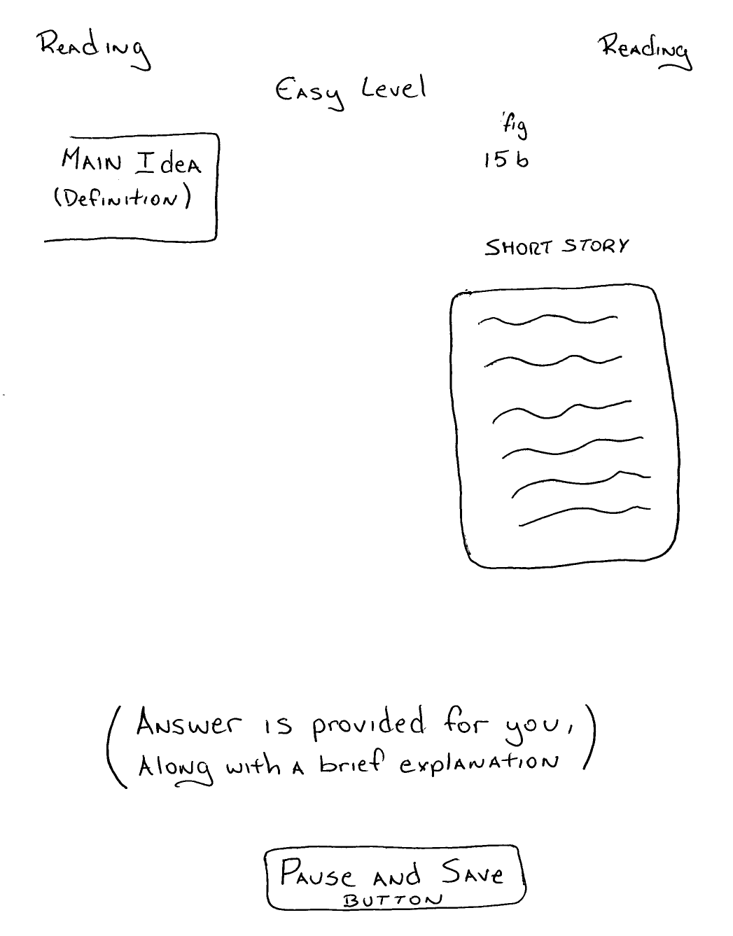

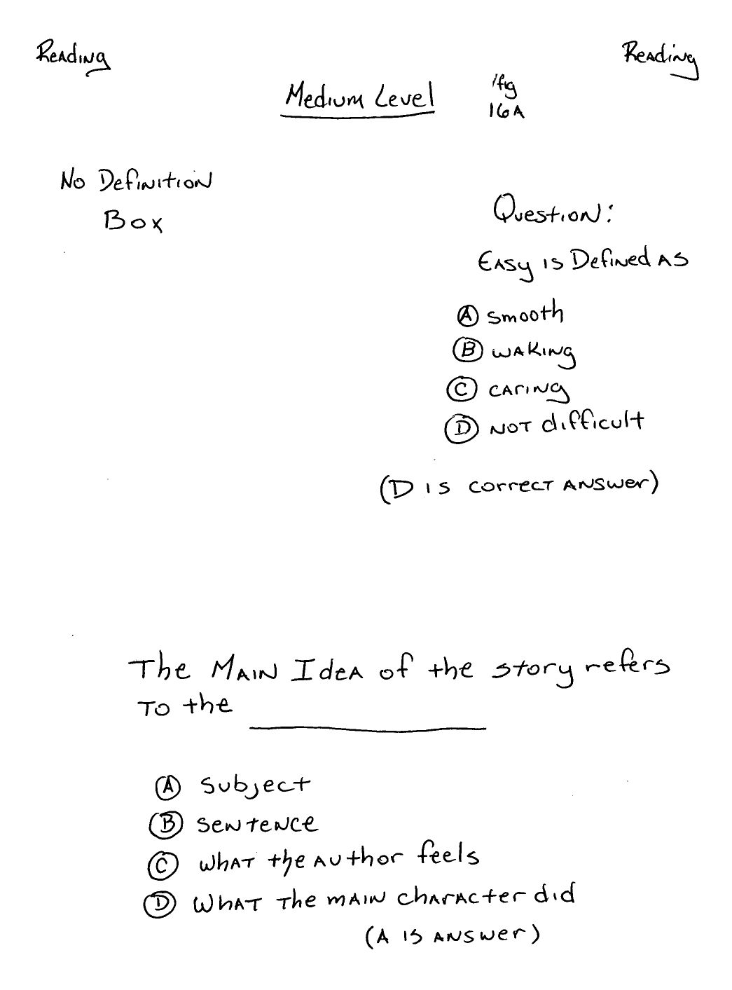

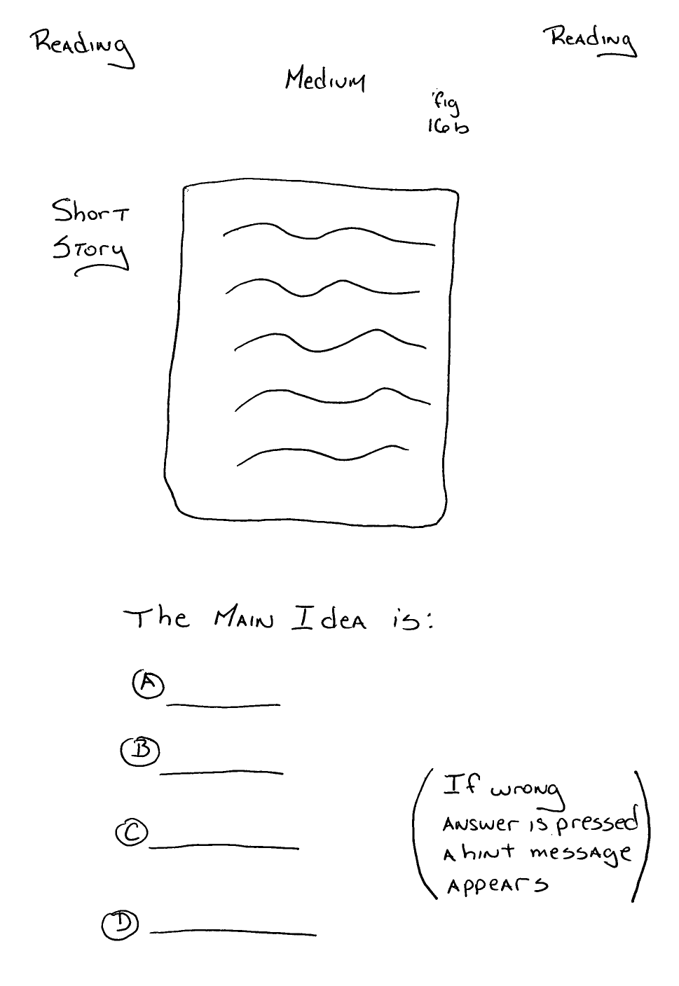

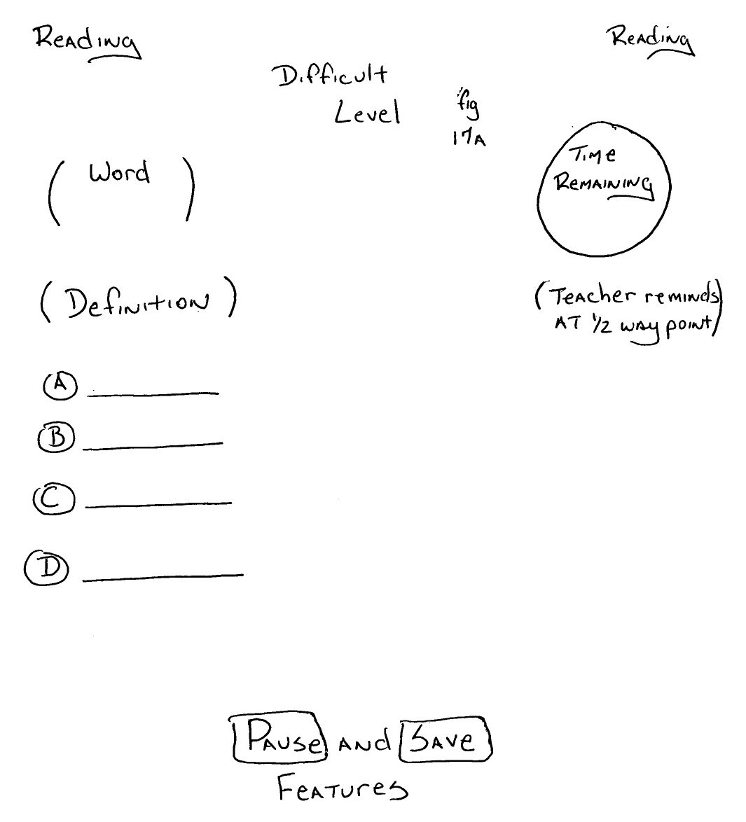

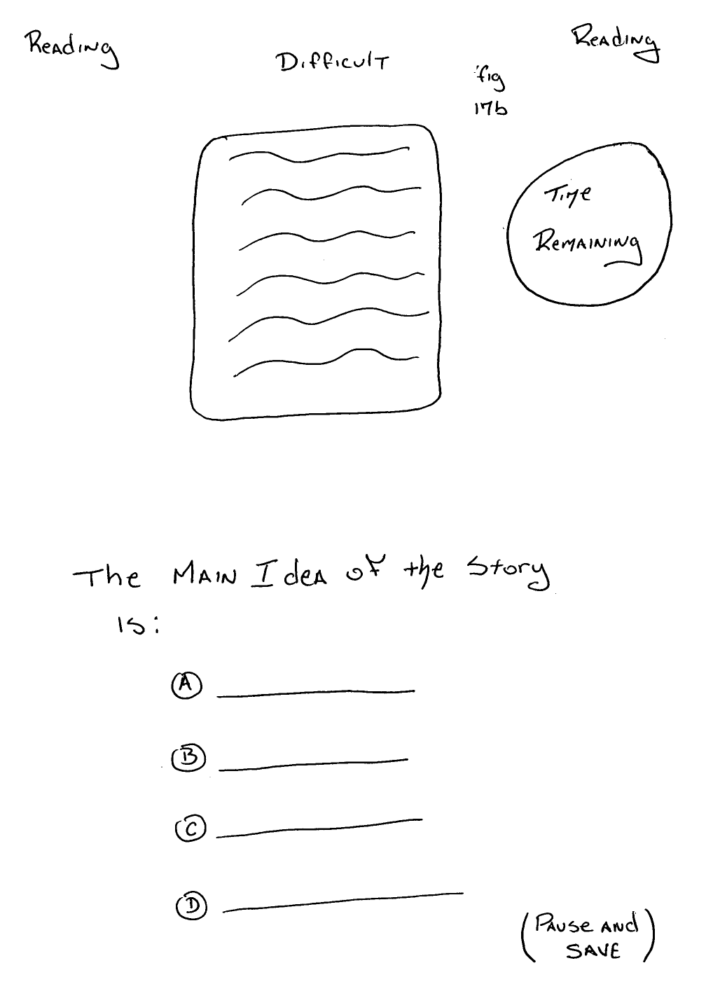

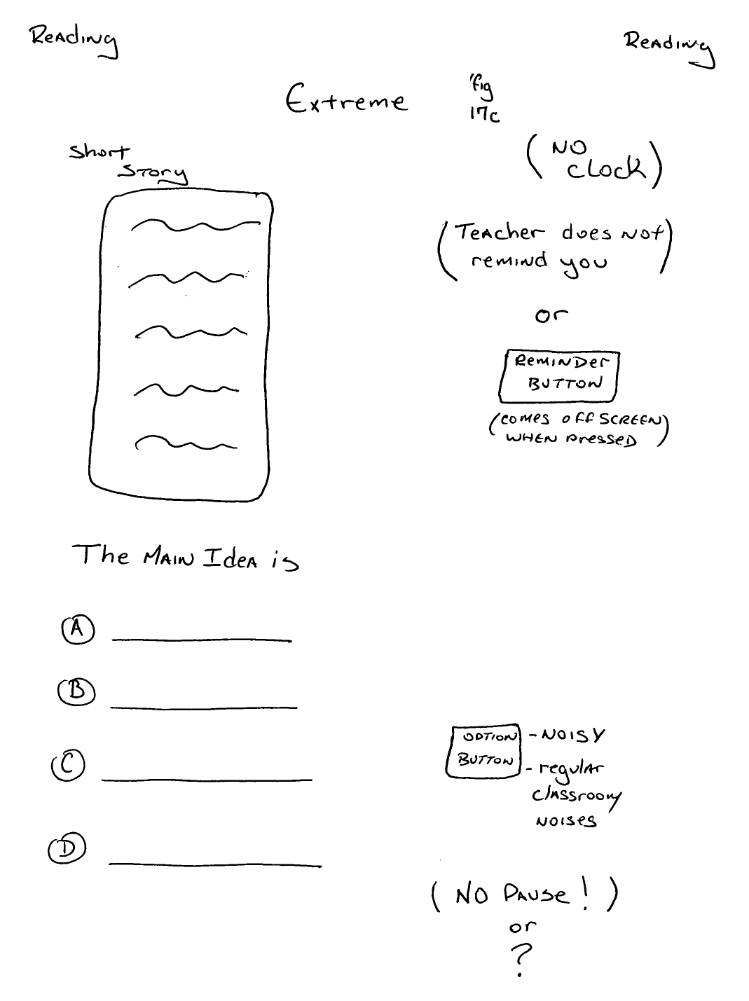

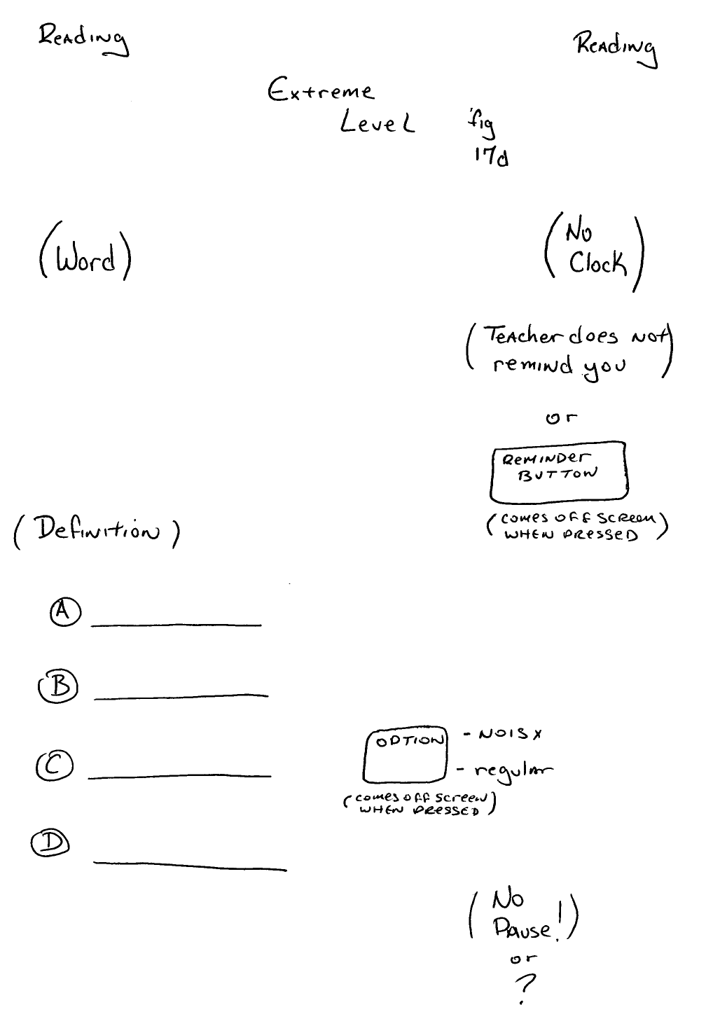

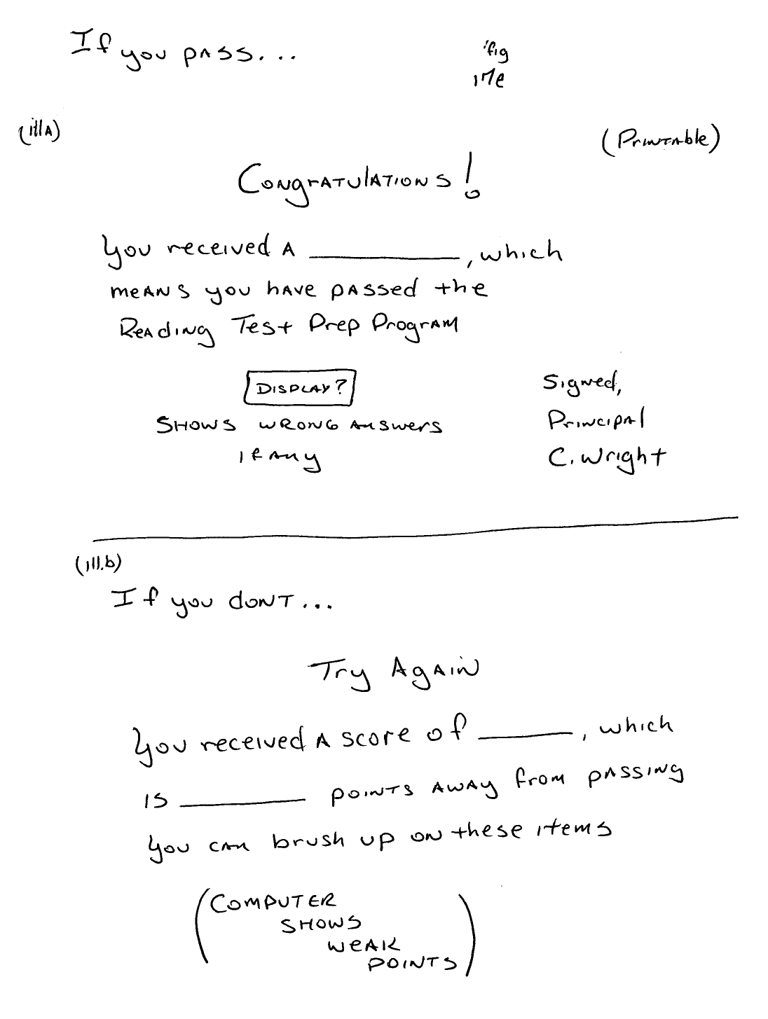

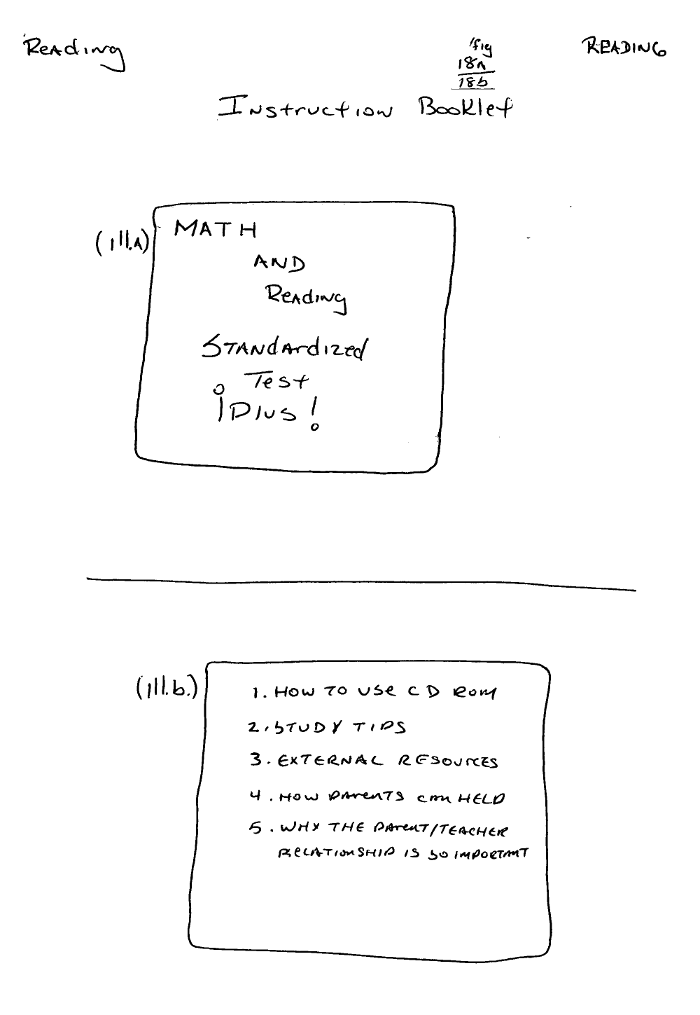

What: Math and Reading Educational Cd-rom directed towards helping children pass the standardized tests, which are a basic requirement of academic promotion. Can be sold as a set, being the two tests are necessary.

Market: Designed for grades 3 to 8.

Parents will purchase to help their children attain the necessary scores.

When speaking of parents, four categories come to mind:
1.) Parents who are not fully aware of the educational system; they want to help the child but simply lack the basic fundamentals to do so (parents learn while children learn).
2.) Parents who work long hours or have more than one job; the time is not there to provide the necessary help.
3.) Parents who are easily frustrated; they do not have the patience required to spend one on one time with their children. When a parent already knows the material, they sometimes forget the fact that they themselves had to learn it. Some at a slower pace than others.
4.) Parents that are totally responsible and simply want their children to receive the necessary test preparation in order to succeed, with regards to taking these exams (Some parents may even want to buy an extra one so their children can begin preparing in the summer for the next grade level).
   COMPETITION: There is currently no educational cd developer with a standardized test preparation cd on the market.
   DEMAND: Always there; as long as there are children attending schools and standardized tests are a requirement. In the case that these standardized tests are ever phased out (highly unlikely), it can double as a cd rom that teaches the children the necessary skills required for that particular grade.
   HOW: 1.) We look at the core curriculum for a particular grade level in the areas of mathematics and reading. 2) Get the Education Departments backing (which you already work closely with). 3) Simulate similar problems and questions in order to create an adequate test environment
   MARKETABILITY: This product will actually sell itself. Once the public sees what this cd roms intended purpose is.
   LEVELS: EASY MEDIUM
   DIFFICULT (X)
   (The levels are actually a play on words. When the child has passed the difficult level, he/she has made the difficult look easy).

### Math Software

HOW SOFTWARE BEGINS: EASY LEVEL

### TITLE SCREEN (see-ill.#1)

You receive a letter in the mail providing you with the following information: (see ill.#2)

1.) Date of test and time
2.) School you must report to
3.) Room number the exam is to be held in and seat number
4.) Teachers name
5) Bring letter and 2 sharpened number two pencils
   NAME AND LEVEL ADJUST (see ill.#3)
:
   It is the day of the test and you begin at home. As you go outside, you meet people whose names simultaneously appear on screen (see ill.#4)(children, adults, cats and dogs) while on your way to the bus (Must be remembered). You get on the bus and say hello to the driver. The bully ties to trip you, but is unsuccessful. You arrive at JUSTIN TYME (just in time) ELEMENTARY SCHOOL. You meet the principal, C. Wright (see right) and the assistant, B. Ready (be ready). (see ill.#5 for rough sketch of bus interior)
   Go through the school entrance doors. While you are walking down the hall, you notice a couple of friends talking. You say hello. Continue walking until you get to the designated classroom, and enter. Sit in assigned seat. You are the first to arrive, so the room is empty. The bell rings and the others come rushing in. The teacher appears through the doors (name appears after she introduces herself) and asks to see everyones letter and identification card. She begins to explain the rules and regulations (50 minute time limit, no talking, no gum chewing, cheating will not be tolerated, if you go to the bathroom during the exam, the clock keeps running). (see ill.#6) The teacher asks if you remembered your pencils. If not, she has extras.
   Before the test is taken, you must provide the names of the people, places and things that you have passed by on your way to the exam (certain questions will be asked). (see ill.#7)
   In order for you to remember the people, places and things, they must be written down (as explained in the instruction manual). Either with scrap paper, or a wipe-off sheet with marker, which can either come with the software, or be sold separately. (see ill.#8)
   Once all the correct data is input, we go to the start screen. (see ill.#9)
   Time to use the scrap paper or wipe off sheet (with marker included)
   In this mode, you put down the first step (A, B, or C). Press enter.
   3 attempts at the incorrect answer and the computer shows the step.
   Data can be saved at any time. (see ill.#10)
   MEDIUM LEVEL: The same introduction as the EASY mode, except ½ of the names are missing. You must fill them in.
   No formula on screen (see ill.#11).
   Both problems and answers appear on screen.
   Pause at any time and save (children can refer to their math book for help; no math book means that you have to refer to the EASY level)
   Difficult level: Same school scenario. This time you must remember all the peoples names to move on.
   By this time you should know that 2 number 2 pencils are necessary to take the exam, the letter, and your identification card. Leaving one thing behind starts you from the beginning of the level.
   There is no pause button. The only 2 options are whether you want the background noise of the children (XTREME DIFFICULT MODE) taking the exam with you or not. No matter which one you choose, the teacher will remind you every 10 minutes of the exam of the time remaining.
   DIFFICULT MODE: A clock counts down the time remaining. (see ill.#12)
   EXTREME DIFFICULT MODE: No clock, just teachers reminders. (see ill.#13)
   At the end, your score is posted with a congratulations certificate, or a “try again” message. (see ill.# 14a&14b)
   Computer will display (if needed) the areas in which you need more practice.
   If you pass, you have the option of printing out your certificate.
   FINAL NOTE: This in no way, shape, or form is the childrens actual exam. Not to be mistaken for their actual test.

### Reading Software

SAME FORMAT AS MATH SOFTWARE. Only variation is the different characters and names that are included during the introduction

Can be based on the English standardized tests of the past or the standard core curriculum for each grade.

Accompanying this program will be a definitions section (children are required to know meanings of certain words, based on their grade level.

LEVELS: EASY MEDIUM DIFFICULT/EXTREME

CONTENTS: 1.) Definitions: children will be expected to know certain words as the school year progresses. Included will be such terms as MAIN IDEA, CONTEXT, SUMMARY, etc.

2.) Story reading/answer section (depending on level, certain tasks will be required).

(Although a definitions section will not appear on every grade leveled exam, it is crucial that you know what is being asked of you.)

(Using the 6^{th} Grade Template as an Example)
Illustration 1—(EASY)—pause and save (see ill.#15a&15b)
Illustration 2—(MEDIUM)—pause and save (see ill.#16a&16b)
Illustration 3—(DIFFICULT)—no pause (see ill.#17a&17b) EXTREME DIFFICULT)

At the end of the difficult phase, you receive a pass/try again message (you don't want to use the word fail, as it may discourage the children from trying again).

A small booklet will accompany each cd-rom explaining what is required of them for that particular grade level, pertaining to that subject (in this case, reading) exclusively. (see ill.# 18a&18b)

Help me to help those who need help, help themselves (the children are our future; we must begin now to ensure a brighter one.).

### THANK YOU

COPYRIGHT Sep. 11, 2003

1. What I claim as my invention is the mathematics and reading standardized test PLUS fully formatted concept. Once manufactured, I truly believe that it will change the way in which elementary education students view the test taking concept. While preparing them for the exams, it will also place them in the type of environment conducive with such factors as test anxiety, not to mention other stressors. Included in this invention is the PLUS! Factor. This provides a level of preparedness for children (during the summer) who are either being promoted, or an enhancer to better inform the children who will be held over of their expectations.
This is a very important factor to consider considering students.
Too many of our youth simply are unprepared to take these exams. Their parents blame the teachers and vice versa. As the saying goes, “The fault lies not in our stars, but in ourselves.” I present a way of test preparation that will revolutionize the school sytems nationwide. The children are our future; we must help them now so they can help us in the future.
There are so many ways that a concept of this proportion can be implemented; possibilities for other subjects are endless. From localities to state, national and even international. If given the opportunity of providing me with this patent, I promise to be as responsible as possible to the needs of our children regarding this beginning of things to come.
